(19) United States
(12) Patent Application Publication
(10) Pub. No.: US 2014/0066092 A1
(43) Pub. Date: Mar. 6, 2014

(54) ADAPTIVE POSITION REPORTING

(71) Applicant: GM GLOBAL TECHNOLOGY OPERATIONS LLC, Detroit, MI (US)

(72) Inventors: Kobi Jacob SCHEIM, Pardess Hanna (IL); Ron ROTSTEIN, Herzlia Petuach (IL); Nadav LAVI, Ramat-Hasharon (IL); Moshe LAIFENFELD, Haifa (IL); Andrew J. MACDONALD, Grosse Pointe Park, MI (US)

(73) Assignee: GM Global Technology Operations LLC, Detroit, MI (US)

(21) Appl. No.: 13/687,788

(22) Filed: Nov. 28, 2012

Related U.S. Application Data
(60) Provisional application No. 61/697,020, filed on Sep. 5, 2012.

(51) Int. Cl. H04W 24/10

(52) U.S. Cl. CPC H04W 24/10
USPC 455/456.1

(57) ABSTRACT

A method includes obtaining data indicative of at least a speed of a mobile communication device. A communication scheme for reporting a position of the mobile communication device is determined, based on at least the speed. The mobile communication device is caused to report its position in accordance with the determined communication scheme.

### CROSS-REFERENCE TO RELATED APPLICATION

This application claims priority under 35 U.S.C. §119(e) to U.S. provisional patent application Ser. No. 61/697,020, filed Sep. 5, 2012, and is incorporated herein by reference in its entirety.

### FIELD OF PRESENT INVENTION

The present invention is related to communications with moving devices.

### BACKGROUND

Traditional telecommunication, e.g. by cellular phones and similar devices, was based on circuit switching, in which a communications channel is opened to connect two communicating devices. More advanced telecommunication devices (sometimes referred to as fourth generation, or 4G, devices) may be based on packet switching. In contrast with circuit switching, in packet switching no dedicated communications channel is opened between the devices. Rather, information to be communicated is organized in the form of addressable data packets. The packets may be routed over the telecommunication network in a manner similar to network communications among computers. One consequence of such packet-based communication may be that a provider of a packet-based telecommunication service or network may charge a customer based on a quantity of communicated information (e.g. a number of communicated packets) rather than on the basis of connection time as is typical for a service based on circuit switching.

Modern cellular systems that are based on packet switching may enable introduction of applications and features that were not as readily available under circuit switch. Such applications may include position monitoring. The integration of Global Positioning System (GPS) receivers into mobile terminals has become common, and may even be considered to be a standard feature that is expected from a mobile phone. The monitored position may be reported on a regular basis to an application that extracts useful information from reported positions of a community of users. For example, such an application may analyze vehicular or pedestrian traffic patterns. Such position information may also be utilized in operation of a network. For example, user location information may enable dynamic control of resource allocation or quasi-static adaptation to exceptional circumstances such as traffic jams or major sports or entertainment events.

For example, one fourth generation cellular standard known as 3GPP-LTE (Third Generation Partnership Project-Long Term Evolution) is designed to support positioning services using data and control streams. An example of an LTE position information transaction may be envisioned as follows: User equipment (UE) may initiate a request-for-location in which a network server provides the location of the UE based on measurements that are reported by the UE to the network. This approach may be useful in cases where the UE does not include a GPS device or where a GPS receiver of the UE does not receive a GPS signal due to shadowing or blocking of the signal. Additionally, the network server may initiate a position request in which it requests the UE to report its position, or another set of measurements that can be analyzed to provide a location of the UE.

### SUMMARY

A method includes obtaining data indicative of at least a speed of a mobile communication device; determining a communication scheme for reporting a position of the mobile communication device, the determination of the communication scheme being based on at least the speed; and causing the mobile communication device to report its position in accordance with the determined communication scheme.

A system includes a processing unit in communication with at least one mobile communication device and with a computer readable medium. The computer readable medium contains a set of instructions wherein the processing unit is designed to carry out the set of instructions to: obtain data indicative of at least a speed of the mobile communication device; determine a communication scheme for reporting a position of the mobile communication device, the determination of the communication scheme being based on at least the speed; and cause the mobile communication device to report its position in accordance with the determined communication scheme.

### BRIEF DESCRIPTION OF THE DRAWINGS

FIG. 1 schematically illustrates an embodiment of a system that is configured for adaptive position reporting;

FIG. 2 schematically illustrates an embodiment of a server that is configured for adaptive position reporting;

FIG. 3 is a flowchart for a method for adaptive position reporting in accordance with an embodiment of the present invention;

FIG. 4 is a graph showing variations in position reporting interval as a result in changes in speed, in accordance with an embodiment of the present invention; and

FIG. 5 is a flowchart of a method for adaptive position reporting that includes implementation of a communication scheme parameterized by a reporting interval.

### DETAILED DESCRIPTION

In the following detailed description, numerous specific details are set forth in order to provide a thorough understanding of the invention. It will however be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that throughout the specification discussions utilizing terms such as “processing,” “computing,” “storing,” “determining,” “evaluating,” “calculating,” “measuring,” “providing,” “transferring,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In accordance with an embodiment of adaptive position reporting, position information may be communicated between a mobile communication device, on the one hand, and another device or server, on the other, in a manner that is determined by a communication scheme. One or more properties of the communication scheme are determined, at least in part, in accordance with a speed of motion of the user device or by other detected conditions. Thus, a position of the mobile communication device may be reported in a manner that is adapted to detected conditions.

A mobile communication device may be understood to include any device with a communication function that is configured to be moveable or transportable. A mobile communication device may include, for example, a handheld or portable device (e.g. mobile telephone, smartphone, portable computer, or similar device with communications capabilities), a vehicle-mounted device (e.g. vehicle-mounted telephone or other communications device, or an onboard computer), or other mobile device (e.g. tracking device that is carried by an animal, or by a water or air current) that is capable of communicating with a remote device at least partly over a wireless network. The mobile communication device may include a capability for determining a position or location of the mobile communication device (or a component of the mobile communication device). For example, the mobile communication device may include a Global Positioning System (GPS) receiver. The mobile communication device may include processing or computing capability. A mobile communication device may be associated with a user or client of a communications service or application.

A server may be understood to include a device, or a collection of intercommunicating devices, that include capability to communicate with one or more mobile communication devices. One or more components of the server may be fixed, or may be portable. For purposes of the description herein, a device may be considered to be providing functionality of a server when motion of that device is not relevant to determination of a communication scheme. For example, some or all function of a server may be included in a mobile communication device. (During communication between two or more mobile communication devices, each of the mobile communication devices may alternate between providing functionality of a mobile communication device and providing functionality of a server.) For purposes of the description herein, a server may include another mobile communication device. A server includes processing or computing capability. A server may be associated with a provider of a communications service or application.

Motion of the mobile communication device may be due to, for example, motion of a person or other agent (e.g. animal or current) that is carrying the mobile communication device, or to motion of a vehicle in which the mobile communication device is being carried or to which the mobile communication device is mounted. A speed of the mobile communication device may be determined by the mobile communication device itself. For example, the speed may be determined from successively measured or reported positions of the device (e.g. as derived from GPS signals). The speed may be determined from an independent device. For example, the speed may be determined from a speedometer of a vehicle that is carrying the mobile communication device.

A communication scheme may include one or more characteristics, properties, or features of communication between the mobile communication device and the server. Such features may include, for example, an interval between successive communications of position information, a rate of communicating position information, selective communication of position information, selecting a mobile communication device from a cluster of mobile communication devices to communicate position information,

For example, a rate of position information communication (a frequency with which position updates are communicated) may increase when a speed of the user device is increased. Similarly, a rate of position information communication may decrease when a speed of the user device is decreased.

In accordance with some embodiments of the present invention, a communication scheme for position information may be affected by factors in addition to speed. For example, when it is determined that a plurality of mobile communication devices are clustered geographically, one of the clustered devices may be selected to represent the cluster's position. The selection may be for a predetermined period of time, after which another mobile communication device of the cluster may be selected to represent the cluster. (Association of a particular mobile communication device with a particular cluster may be fluid, and may be redefined periodically or as required. Positions of the devices in the cluster may be checked periodically to verify that the membership of the cluster had not changed.) In this case, communication of position information between the representative device and another device, such as a server, may be interpreted as representing communication between all mobile communication devices of the cluster and the server. Reported position information regarding the representative device may be interpreted as applicable (e.g. with some adjustment, such as for relative placement of each mobile communication device within the cluster) to all of the mobile communication devices in the cluster.

As another example, a communication scheme for position information between a mobile device and a server may be affected by information regarding infrastructure. Information that is obtained regarding an infrastructure (e.g. roadway, pedestrian lane, railroad, boat lane) may be interpreted as being related to mobility of the mobile communication device. Such infrastructure information may be obtained from a sensor that is associated with the mobile communication device, or may be reported and communicated by a controller or processor that is associated with the infrastructure (e.g. directly or via a server). For example, when the mobile device is associated with a vehicle, information may be received with regard to a current status of a traffic signal or traffic sensor, or of other controls (e.g. a railroad switch, bridge position, road conditions report, or weather report). Such received information may be incorporated in a determination of communication scheme or of an interval between successive position-related communications.

An example of incorporation of such received information into determination of a communication scheme may include obtaining information of a traffic signal that is in a current direction of motion of a motor vehicle. For example, a camera or other imaging device that is associated with the mobile device may sense a red stoplight ahead of the motor vehicle. As another example, a controller for the stoplight may broadcast a signal that indicates a current state of the stoplight. Thus, an assumption that the motor vehicle is stationary due to the red light may be incorporated into determining a communication scheme (e.g. increasing an interval between successive communications).

Adaptive position reporting in accordance with embodiments of the present invention may be advantageous.

For example, communication of position information may be based on packet switching communication. With packet switching, use of a mobile communication device may be monitored for a quantity of data (e.g. number of data packets) that is sent by the mobile communication device. A subscriber to service that includes position reporting may be billed or charged in accordance with the monitored quantity of transmitted or reported data. Thus, a communication scheme that reduces the quantity of transmitted position data may result in savings for a user of the mobile communication device without reducing the accuracy of the reported positioning.

Similarly, a server may receive position data that are transmitted from a large number of mobile communication devices. There may be conditions of increased load, when the server receives data from increased numbers or densities of mobile communication devices (e.g. rush hour traffic). A communications scheme that reduces the quantity of received position data may enable the server to provide service to an increased number of mobile communication devices without increasing communications or power resources of the server.

Some or all of reported position data may be saved temporarily or permanently by a server that receives the data. For example, the received data may be saved on one or more memory or data storage units or devices that are associated with the server. A communications scheme that reduces the quantity of received position data may enable the server to efficiently utilize available data storage resources.

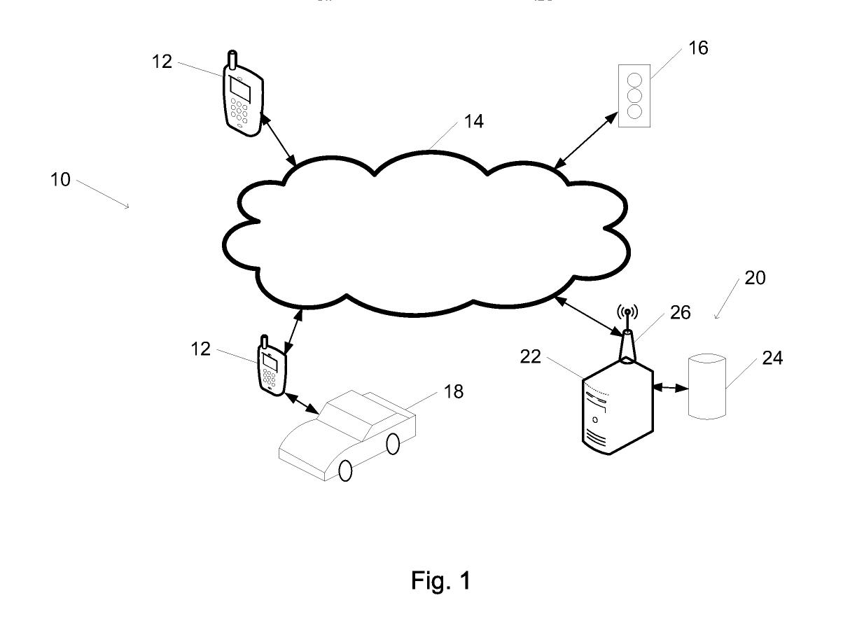

A position reporting system may be configured to operate in accordance with embodiments of adaptive position reporting. FIG. 1 schematically illustrates an embodiment of a system that is configured for adaptive position reporting.

Position reporting system 10 is configured for position reporting by one or more mobile communication devices 12. Each mobile communication device 12 is configured to communicate at least with a server 20 via a network 14.

A mobile communication device 12 may include a portable or transportable device that is capable of reporting a position (location) of mobile communication device 12. For example, a mobile communication device 12 may be provided with a GPS receiver. As another example, a mobile communication device 12 may be capable of determining its position in relation to fixed objects (e.g. antennas). Mobile communication device 12 may include, for example, a mobile telephone, a smartphone, a portable or handheld computer, a vehicle's onboard computer, a GPS device, or any other device that is transportable from one location to another and that is provided with capability to determine and report its position (e.g. geographical coordinates in one or more directions).

Inclusion position reporting system 10 may be limited to those mobile communication devices 12 that are registered or otherwise indicated as being included within position reporting system 10. For example, the mobile communication device 12, a user of mobile communication device 12, or a vehicle with which mobile communication device 12 is associated, may subscribe to position reporting service that is associated with position reporting system 10.

Mobile communication device 12 may include processing capability for performing in accordance with programmed instructions. In other cases, mobile communication device 12 may be provided with minimal processing capability. In such a case, processing that is associated with mobile communication device 12 may be performed by one or more remote processors. A remote processor may include, for example, a processor of another mobile communication device 12, or of a server 20.

Network 14 may include any network that enables communication between mobile communication device 12 and one or more remote devices or systems. The remote devices may include another mobile communication device 12, a server 20, or an infrastructure-related device or system such as infrastructure device 16. Network 14 may include a wired or wireless network. For example, in a case that mobile communication device 12 is freely transportable, network 14 may include a wireless component. In other examples, mobile communication device 12 may be constrained to movement along predetermined lanes or tracks (e.g. when mobile communication device 12 is transported by a railroad, trolley, or cable car). In such a case, network 14 need not, but may, include a wireless component.

Network 14 may represent two or more separate networks. For example, one of the separate networks may enable communication between mobile communication device 12 and server 20. Another separate network may enable communication between infrastructure device 16 and server 20.

A mobile communication device 12 may be associated with, or transported by, a vehicle 18. For example, mobile communication device 12 may be associated with a passenger of vehicle 18. Mobile communication device 12 may be associated with a driver or operator of vehicle 18. For example, mobile communication device 12 may include a personal smartphone or portable computer of the passenger, driver, or operator. In another example, mobile communication device 12 may include an onboard computer, GPS device, or communications device that is incorporated into vehicle 18. Mobile communication device 12 may represent two or more intercommunicating devices. For example, mobile communication device 12 may include a portable device that communicates with an onboard device. A position or speed of mobile communication device 12 may thus be indicative of a position or speed of vehicle 18.

Infrastructure device 16 may include a device or sensor that is associated with an infrastructure that monitors or controls pedestrian or vehicle traffic. For example, infrastructure device 16 may include a traffic signal (e.g. a traffic light) for controlling pedestrian or vehicle traffic, a sensor system for monitoring a state of traffic (e.g. camera for imaging traffic conditions, an active or passive sensor system for monitoring a state of traffic, or an analysis system for analyzing acquired image or sensor data so as to determine a traffic condition).

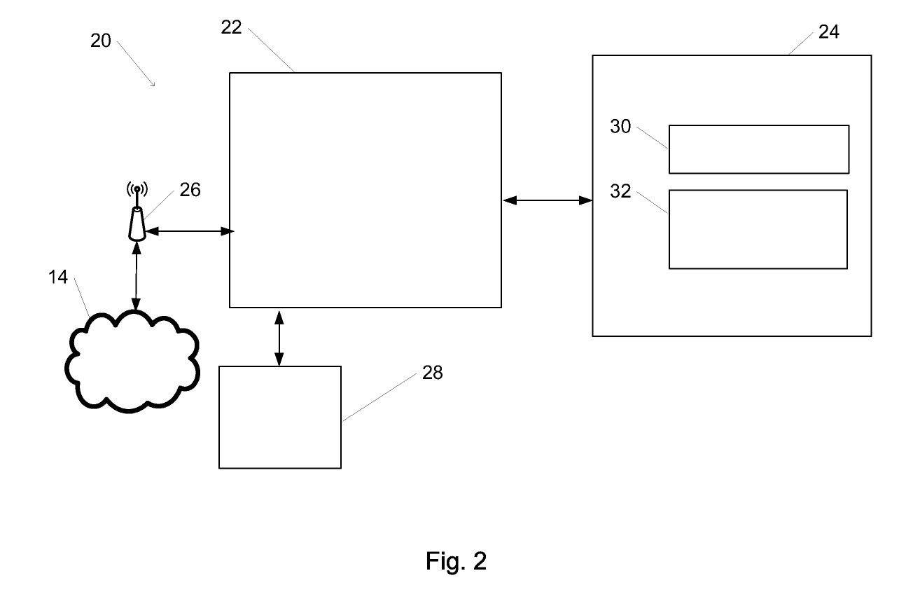

Position reporting system 10 includes server 20. FIG. 2 schematically illustrates an embodiment of a server that is configured for adaptive position reporting.

Server 20 includes a processor 22. Processor 22 may include one or more devices with processing capability. For example, processor 22 may be incorporated into a computer, or a plurality of intercommunicating computers, that is associated with server 20. Some or all of the functionality of processor 22 may be distributed among remote computers or processors. Such a remote processor may include a processor of a mobile communication device 12 or an infrastructure device 16.

Processor 22 may operate in accordance with programmed instructions. Such programmed instructions may include instructions for an embodiment of a method for adaptive position reporting.

Processor 22 may communicate with memory 28. Memory 28 may include one or more volatile or nonvolatile memory devices. Memory 28 may be utilized to store, for example, programmed instructions for operation of processor 22, data or parameters for use by processor 22 during operation, or results of operation of processor 22

Processor 22 may communicate with data storage device 24. Data storage device 24 may include one or more fixed or removable nonvolatile data storage devices. For example, data storage device 24 may include a computer readable medium for storing program instructions for operation of processor 22. In accordance with embodiments of the present invention, the programmed instructions may take the form of motion analysis module 30 for analyzing motion of one or more mobile communication devices 12, or communication scheme determination module 32 for determining a communication scheme for position reporting by one or more mobile communication devices 12.

It is noted that storage device 24 may be remote from processor 22. In such cases storage device 24 may be a storage device of a remote server storing motion analysis module 30 or communication scheme determination module 32 in the form of an installation package or packages that can be downloaded and installed for execution by processor 22. Data storage device 24 may be utilized to store data or parameters for use by processor 22 during operation, or results of operation of processor 22.

Processor 22 may communicate with one or more other devices via network connection 26. For example, network connection 26 may enable connection of processor 22 directly to a wireless network 14, and/or to a wire-based network 14. Connection of processor 22 to network 14 may enable processor 22 to communicate with one or more mobile communication devices 12, and/or with one or more infrastructure devices 16.

Processor 22 may be operated to execute a method for adaptive position reporting.

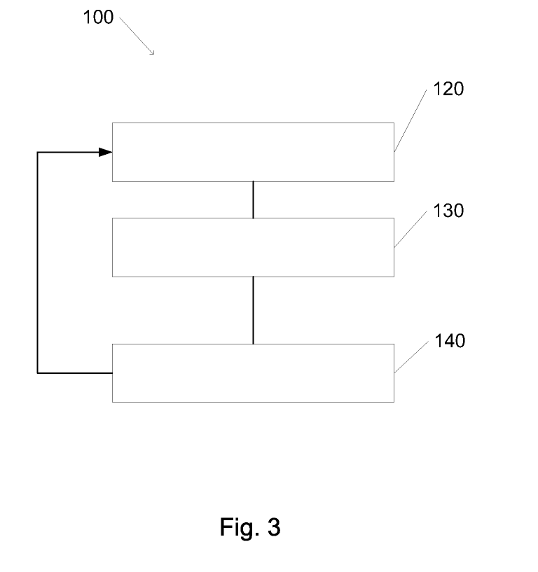

FIG. 3 is a flowchart for a method for adaptive position reporting in accordance with an embodiment of the present invention. Position reporting method 100 may be executed by a processor of a server of a system for adaptive position reporting in accordance with an embodiment of the present invention. Position reporting method 100 may be executed by a processor of a mobile communication device or of another device.

It should be understood with regard to flowcharts that are referenced herein that division of the illustrated method into discrete operations as represented by blocks of the flowchart has been selected for convenience and clarity only. Alternative division of the illustrated method into operations represented blocks is possible, with equivalent results. Any such alternative division into of the illustrated method into discrete operations should be understood as included within the scope of embodiments of the present invention.

It should also be understood with regard to flowcharts that are referenced herein that, unless indicated otherwise, the order of operations of the illustrated method as represented by ordering of blocks of the flowchart has been selected for convenience and clarity only. Operations of the illustrated method may be executed in a different order, or concurrently, with equivalent results. Any such alternative ordering of operations as represented by blocks should be understood as included within the scope of embodiments of the invention.

Position reporting method 100 may be executed periodically, e.g. at predetermined intervals, or may be initiated in response to a sensed event. Execution of position reporting method 100 may determine (as described below) when position reporting method 100 is to be executed subsequently. Execution of position reporting method 100 may be triggered by a sensed event, e.g. by a sensed change in reported position, by a sensed action by a vehicle (e.g. acceleration or braking of a vehicle as sensed by a sensor that communicates with an onboard computer of the vehicle and as reported to a processor that executes position reporting method 100), or by a sensed change in traffic conditions (e.g. as reported by an infrastructure device).

Position data of a mobile communication device is obtained (block 120). For example, reporting of position data may be initiated by the mobile communication device or may be requested by a server.

Data may be obtained for a position of the mobile communication device at two or more different times. Obtained position data may include geographic coordinates of the mobile communication device, or data from which geographical coordinates may be derived. Obtained position data may include a speed or velocity (vector quantity) of the mobile communication device, or may include reporting position data at two or more reported times (or at known intervals) such that speed or velocity data may be derived.

Data may be obtained for a plurality of mobile communication devices. For example, the mobile communication devices may be located within a single geographical distance from one another. As another example, the mobile communication devices may be determined to be traveling along a common roadway or track, or may be traveling toward a common intersection.

A communication scheme may be determined on the basis of the obtained position data (block 130). A communication scheme may determine an interval between subsequent consecutive position reports. For example, an interval between consecutive position reports may be increased when a speed of the mobile communication device is decreased. On the other hand, an interval between consecutive position reports may be decreased when a speed of the mobile communication device is increased.

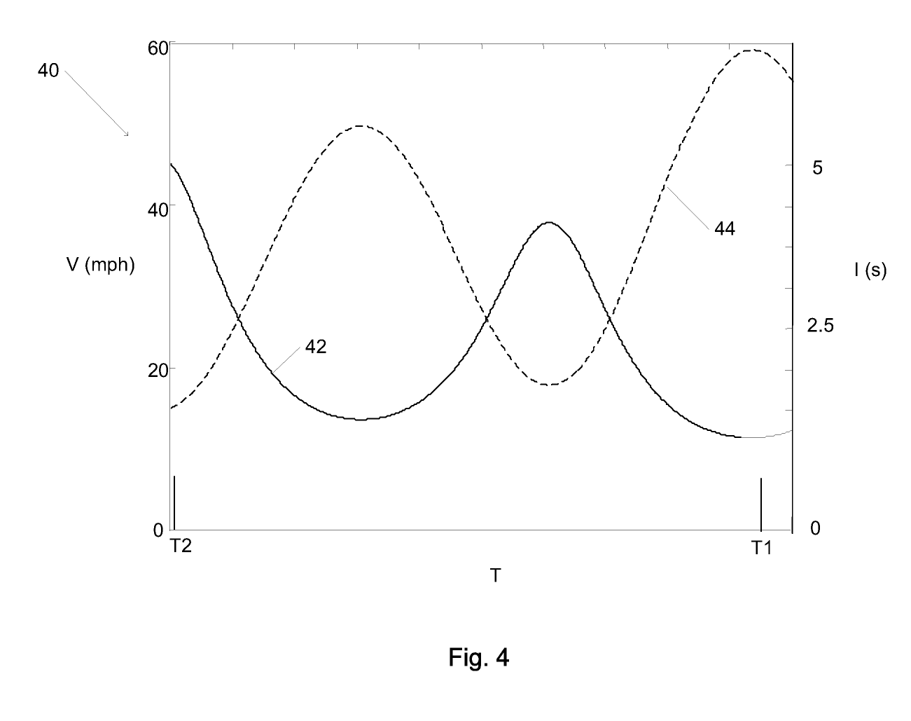

FIG. 4 is a graph illustrating variations in a position reporting interval as a result of changes in speed, in accordance with an embodiment of the present invention.

In graph 40, curve 42 indicates a variation in position reporting interval I, in units of seconds (s), over the course of time T. Curve 44 indicates a variation in speed V of a mobile communication device (e.g. mounted in a vehicle) in units of miles per hour (mph) over the course of the same time T. As indicated by curves 42 and 44, when speed V is increased, reporting interval I is decreased. For example, at time T1, speed V is approximately 60 miles per hour, while reporting interval I is about one second. At time T2, speed V is about 15 miles per hour while reporting interval I is about 4.5 seconds. Thus, in the example shown, when the mobile communication device is traveling slowly the rate reporting the position may be reduced by a factor of about four compared to when the mobile communication device is traveling quickly.

A communication scheme may also be determined on the basis of a detected clustering of mobile communication devices. For example, obtained position data from a plurality of mobile communication devices may indicate that those mobile communication devices are located within a single geographic area. The size of the area may be determined on the basis of one or more predetermined criteria (e.g. speeds of the mobile communication devices or geographical setting). The number of mobile communication devices in a cluster may be limited in accordance with predetermined criteria. Similarly, inclusion in a cluster may depend on one or more factors that indicate whether the mobile communication devices are likely to continue to remain near to one another. For example, a plurality of mobile communication devices may be include in a cluster only if they are moving slowly (e.g. compared to a threshold speed; the threshold speed may depend on local conditions, such as a speed limit at the location) or on conditions of the infrastructure (e.g. presence or state of traffic signals, presence of intersections, type of roadway or track).

If clustering is detected, a communication scheme may include selecting one or more of the mobile communication devices in the cluster to function as representative devices. Different mobile communication devices of the cluster may be selected sequentially to function as representative devices at different times.

Clustering may be detected by analysis of reported positions of a plurality of mobile communication devices, e.g. by a server. In other cases, clustering may be detected via communication among the mobile communication devices themselves (e.g. vehicle-to-vehicle communication).

The device that is executing position reporting method 100 may then cause the determined communication scheme to be implemented (block 140). The determined communication scheme may be implemented internally by the device that executes position reporting method 100, or externally by another external device. If the communication scheme is to be executed externally, the communication scheme may be communicated to the external device. For example, one or more parameters (e.g. a reporting interval) that are associated with, or that define, the communication scheme may be communicated to the external device.

For example, in the case that position reporting method 100 is being executed by a server, the communication scheme may be implemented internally by that server. On the other hand, the communication scheme may be implemented externally, e.g. by a processor of mobile communication device. The communication scheme, or one or more parameters of the communication scheme, e.g. a reporting interval, may be communicated to the mobile communication device. The mobile communication device may then implement the communication scheme.

As another example, position reporting method 100 may be executed by a mobile communication device. The communication scheme may be implemented internally by that mobile communication device. On the other hand, the communication scheme may be implemented externally, e.g. by a processor of a server. The communication scheme, or one or more parameters of the communication scheme, e.g. a reporting interval, may be communicated to the server. The server may then implement the communication scheme, e.g. by requesting position reporting from a mobile communication device in accordance with the communicated communication scheme.

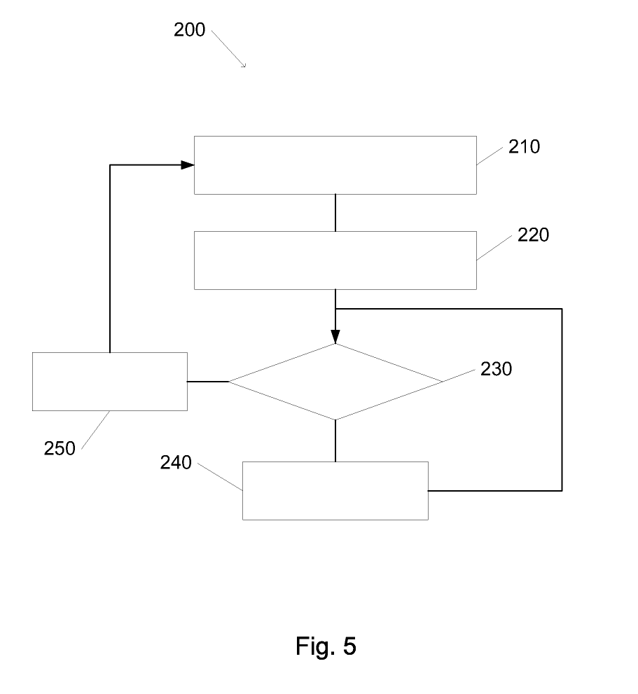

For example, a communication scheme may determine an interval at which a position of a mobile communication device is to be reported. FIG. 5 is a flowchart of a method for adaptive position reporting that includes implementation of a communication scheme parameterized by a reporting interval.

Position reporting method 200 may be executed by a processor, e.g. of a server or of a mobile communication device. For example, position reporting method 200 may be executed by a scheduler module or by an application being executed by the processor.

When position reporting method 200 is executed by a processor of a server, position reporting may be initiated by the server in accordance with a communication scheme. For example, the server may send a message, request, or command to a mobile communication device that indicates that a position report is to be sent by the mobile communication device to the server. The mobile communication device may reply with a position report. (In accordance with some communications protocols, additional communications may be sent between the server and the mobile communication device in order to establish or initialize communication between the mobile communication device the server.) The position report may include a report of a single position at the time requested by the server. In other cases, the mobile communication device may continue to send position reports at an interval that is defined by data that was communicated to the mobile communication device by the server. The communication of consecutive position reports may continue until a message is sent by the server that indicates that position reporting is to stop or is to continue in accordance with a different communication scheme.

When position reporting method 200 is executed by a processor of a mobile communication device, position reporting may be initiated by the mobile communication device in accordance with a communication scheme. (In accordance with some communications protocols, additional communications may be sent between the server and the mobile communication device in order to establish or initialize communication between the mobile communication device the server.)

A reporting interval as determined by a communication scheme may be obtained (block 210). For example, the communication scheme may be determined by a processor that is executing position reporting method 200. The communication scheme may be determined by a processor other than the processor that is executing position reporting method 200, e.g. of another device. The other processor may communicate the communication scheme, or a reporting interval that is derived from the communication scheme, to the processor that is executing position reporting method 200.

The processor that is executing position reporting method 200 may start a clock, timer, or a timing application (block 220). For example, an initial time may be initialized, e.g. to zero. As another example, a starting time may be stored as read from a continuously running clock, e.g. of a processor.

A time as measured by the timer (or a time difference between a current time and a starting time) may be compared with the obtained reporting interval (block 230). For example, a time may be read or measured at predetermined intervals and compared with the reporting interval.

If the measured time is less than the reporting interval, the processor waits until the next timer measurement or clock reading (block 240) and repeats the comparison (returning to block 230).

If the measured time exceeds the interval, the position of the mobile communication device is reported (block 250). In accordance with another embodiment of the present invention, the timer is initialized with the time interval and a countdown operation is carried out. For this case the clock reading is compared with zero. Thus, when the clock reading is less than zero, the position of the mobile communication device is reported.

For example, if position reporting method 200 is being executed by a processor of the mobile communication device, the mobile communication device may send a reported position to a server. If position reporting method 200 is being executed by a server, the server may send a command or message to the mobile communication device that indicates that the mobile communication device is to report a position to the server.

Embodiments of the present invention may include apparatus for performing the operations described herein. Such apparatus may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments of the invention may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A method comprising:
obtaining data indicative of at least a speed of a mobile communication device;
determining a communication scheme for reporting a position of the mobile communication device, the determination of the communication scheme being based on at least the speed; and
causing the mobile communication device to report its position in accordance with the determined communication scheme.

2. The method of claim 1, wherein the mobile communication device is associated with a vehicle such that the obtained data or the reported position is indicative of at least a position or speed of the vehicle.

3. The method of claim 1, wherein the obtained data or the reported position comprise Global Positioning System (GPS) data.

4. The method of claim 1, wherein obtaining data comprises obtaining data that is indicative of at least a position and a speed of each of a plurality of mobile communication devices.

5. The method of claim 4, wherein determining the communication scheme comprises identifying a cluster of mobile communication devices from among said plurality of mobile communication devices.

6. The method of claim 5, wherein identifying the cluster comprises obtaining said that is indicative of at least a position and a speed of one of the mobile communication devices by another of the mobile communication devices.

7. The method of claim 4, wherein determining the communication scheme comprises selecting a representative mobile communication device from the mobile communication devices of the cluster.

8. The method of claim 1, wherein determining the communication scheme comprises determining a reporting interval.

9. The method of claim 8, wherein a length of the reporting interval increases when the speed decreases.

10. The method of claim 1, wherein causing the mobile communication device to report its position comprises communicating the communication scheme to the mobile communication device.

11. The method of claim 1, wherein causing the mobile communication device to report its position comprises operating the mobile communication device in accordance with communication scheme.

12. The method of claim 1, comprising obtaining infrastructure data.

13. The method of claim 12, wherein determination of the communication scheme is additionally based on the obtained infrastructure data.

14. The method of claim 12, wherein the infrastructure data comprises a status of a traffic signal.

15. A system comprising:
a processing unit in communication with at least one mobile communication device and with a computer readable medium, wherein the computer readable medium contains a set of instructions wherein the processing unit is designed to carry out the set of instructions to:
obtain data indicative of at least a speed of said at least one mobile communication device;
determine a communication scheme for reporting a position of said at least one mobile communication device, the determination of the communication scheme being based on at least the speed; and
cause said at least one mobile communication device to report its position in accordance with the determined communication scheme.

16. The system of claim 15, wherein said at least one mobile communication device is associated with a vehicle such that the obtained data or the reported position is indicative of a speed or position of the vehicle.

17. The system of claim 15, wherein the processing unit is in communication with said at least one mobile communication device via a network.

18. The system of claim 17, wherein the network is a wireless network.

19. The system of claim 17, wherein the network is a packet-switched network.

20. The system of claim 15, wherein the processing unit is in communication with an infrastructure device.
